(19) United States
(12) Patent Application Publication
(10) Pub. No.: US 2006/0170415 A1
(43) Pub. Date: Aug. 3, 2006

(54) Device for recording a rotational movement in a vehicle steering system

(76) Inventors: Martin Budaker, Heubach (DE); Michael Haegele, Aalen (DE); Markus Heger, Schwaebisch Gmuend (DE); Michael Ochs, Bartholomae (DE)

Correspondence Address: KENYON & KENYON LLP, ONE BROADWAY, NEW YORK, NY, 10004, US

(21) Appl. No.: 10/562,510

(22) PCT Filed: Jun. 18, 2004
(86) PCT No.: PCT/EP04/06565

§ 371 Date: Dec. 27, 2005

(30) Foreign Application Priority Data
Jun. 30, 2003 (DE) 103292934

(51) Int. Cl. G01B 7/14

(52) U.S. Cl. 324/207.13; 324/207.25

(57) ABSTRACT

A device is for measuring an angular movement in a vehicle steering system. A shaft, whose angular movement is to be measured, is rotationally mounted in a frame. Positioned on the shaft is an axially displaceable element, which is connected to the shaft via a geared connection that converts the angular movement of the shaft into a longitudinal movement. The geared connection may be a screw thread or a screw-like, sliding-block guide or a recirculating ball screw, etc. The axially displaceable element is axially guided with the aid of a longitudinal guide prestressed in the radial direction and, in particular, by a frame-side component of the longitudinal guide. A detection device made up of a transducer on the axially displaceable element and a sensor on the frame detects the longitudinal movement of the axially displaceable element. In order to render the geared connection, together with the longitudinal guide, backlash-free, it is provided that the frame-side component rest against the axially displaceable element on first oblique surfaces that extend at an angle to each other and in the axial direction of the axially displaceable element, and that the axially displaceable element and the shaft mesh in a backlash-free manner via second oblique surfaces of the geared connection. The first oblique surfaces and the second oblique surfaces have the same inclination directions with respect to each other.

### FIELD OF THE INVENTION

The present invention relates to a device for measuring an angular movement, as well as to a steering system equipped with it.

### BACKGROUND INFORMATION

German Published Patent Application No. 100 37 211 describes a device for measuring an angular movement of a steering handle of a vehicle steering system. An axially displaceable element situated on a steering shaft forms, together with a geared connection on the steering shaft taking the form of a thread, a lead screw. The axially displaceable element is axially guided in a longitudinal guide made up of a sliding rod on the element and a guide channel for the sliding rod. In this context, a magnetic irregularity on the axially displaceable element is detected by a galvanomagnetic sensor, and the longitudinal movement of the axially displaceable element is measured. This does allow the angular motion of the steering handle to be measured absolutely, but the described device is not exact due to the unavoidable backlash of the longitudinal guide.

European Published Patent Application No. 1 114 765 describes a device for measuring an angular movement in a vehicle steering system, the angular movement of the shaft to be measured being converted into an angular movement of a screw shaft. The angular movement of the screw shaft is measured in a manner similar to that of the shaft described in German Published Patent Application No. 100 37 211, the axially displaceable element being able to be spring-loaded in the radial direction of the shaft.

The device described in European Published Patent Application No. 1 114 765 is expensive to manufacture and requires a relatively large amount of space. In addition, there is no position or setting of the longitudinal guide of the axially displaceable element that is completely backlash-free. This reduces the measurement accuracy of the device.

### SUMMARY

An example embodiment of the present invention may provide a device for measuring an angular movement in a vehicle steering system, which may provide a very high measurement accuracy, while having a simple design and requiring very little space. In addition, a steering system equipped with the device may be provided.

A shaft is rotationally mounted in a frame, an element that is axially displaceable in the direction of the shaft being situated on the shaft, and the element being connected to the shaft via a geared connection that converts the angular movement of the shaft into a longitudinal movement. The axially displaceable element is guided in an axial direction by a longitudinal guide prestressed in a radial direction of the shaft, a detection device measuring the longitudinal movement of the axially moveable element being provided. According to an example embodiment of the present invention, a frame-side component rests against the axially displaceable element at first oblique surfaces that extend at an angle to each other and in the axial direction of the axially displaceable element. The axially moveable element and the shaft mesh without backlash via second oblique surfaces of the geared connection, the first oblique surfaces and the second oblique surfaces having the same directions of inclination with respect to each other. Both the first and second oblique surfaces are arranged to have the same shape, the first and second oblique surfaces having the same, e.g., trapezoidal directions of inclination. In other words: the first oblique surfaces provided for the axial guidance are formed the same as the second oblique surfaces along the direction of rotation of the geared connection. This may provide that a radially directed pressure applied via the frame-side component to the first oblique surfaces causes the second oblique surfaces in the geared connection to press against each other, and consequently may provide a sufficient lack of backlash that may ensure an effective keyed connection.

This easily produced, backlash-free setting of the device for measuring an angular movement may allow a high measuring accuracy of the device. Therefore, a highly accurate sensor measuring device may be produced.

The geared connection between the shaft and the axially moveable element may be screw-like or thread-like and may have suitable (second) oblique surfaces on the shaft and/or (first) oblique surfaces on the axially moveable element, which rest against one another. The oblique surfaces of the geared connection and the oblique surfaces between the frame-side component and the axially moveable element each have the same inclination directions. The frame-side component may be a thrust piece, which is prestressed, for instance, by spring force or hydraulic pressure. The moveable element may take the form of a nut, which is axially guided on the shaft that takes the form of a screw thread or worm.

By prestressing the frame-side component of the longitudinal guide in the direction of the axially moveable element, or also away from the axially moveable element as a function of the inclination direction of all of the oblique surfaces, all of the mentioned oblique surfaces may make contact without backlash, which may result in a high measurement accuracy of the detection device between the support and the axially moveable element.

It may be provided to position the first oblique surfaces on the axial moveable element in an axially guided groove directed radially from the surface of the element to its longitudinal axis. In this context, the groove may have a trapezoidal cross-section.

In this groove, the edges, i.e., the (first) oblique surfaces, of the frame-side component of the longitudinal guide may come in contact with the (first) oblique surfaces of the groove, which may result in backlash-free longitudinal guidance of the axially moveable element.

In this context, the axially moveable element may be formed around the shaft in the shape of a ring or cylinder or sleeve or polygon, the geared connection between the shaft and the axially displaceable element being able to take the form of a screw thread, one that forms a lead screw. The screw thread may take the form of a trapezoidal thread or a ball-screw thread.

In order to minimize the space requirement of the device for measuring an angular movement, the main portion of the radial extension of the frame-side component of the longitudinal guide is accommodated in the groove of the axially displaceable element.

The angular movement of the shaft is converted by the geared connection between the shaft and the axially displaceable element into a longitudinal movement of the same. The longitudinal displacement of the axially displaceable element is measured by the detection device having an evaluation circuit. For this purpose, a sensor or a transducer is positioned at the circumference of the axially displaceable element, the sensor or transducer communicating with a transducer or sensor that is situated adjacent to it on the frame or frame-side component of the longitudinal guide.

The sensor may be a magnetoresistive sensor, which is mainly made up of one or more meander-shaped conductor tracks made of a ferromagnetic nickel-cobalt alloy, which is vapor-deposited on a silicon substrate and passivated by a protective silicon-nitride layer. The resistance of the ferromagnetic nickel-cobalt alloy is a strong function of a magnetic field with respect to the magnetic-field direction.

The transducer may be a bar magnet, whose axial extension may be greater than that of the structurally predetermined measuring range of the longitudinal movement of the axially displaceable element, in order to allow for an installation tolerance of the transducer or the axially displaceable element relative to the sensor. It may also be provided for the transducer to take the form of an annular magnet.

In particular, in order to allow redundancy in the detection device, it may be provided to position a plurality of sensors and transducers communicating with them, in the circumferential direction and/or longitudinal direction of the axially displaceable element, and on the frame.

It may be provided for the axially displaceable element to be a nut, which is positioned on a shaft in the form of a steering spindle, so as to be axially movable. This arrangement may be particularly suited for detecting the steering angle in the region of the steering handle (steering wheel).

It may also be provided for the displaceable element to take the form of a threaded nut, the shaft taking the form of a threaded part, on which the threaded nut is positioned so as to be axially movable. The threaded part is attached, in turn, to a steering nut, which acts on a gear rack via a ball-screw thread. Therefore, the steering angle may also be measured in the region of the gear rack, using the provided measuring device.

Exemplary embodiments of the present invention are described in more detail below with reference to the appended Figures.

### BRIEF DESCRIPTION OF THE DRAWINGS

FIG. 1 is a schematic cross-sectional view of a device for measuring an angular movement at a steering spindle.

FIG. 2 is a schematic longitudinal cross-sectional view of the measuring device illustrated in FIG. 1, taken along line I-I.

FIG. 3 is a schematic cross-sectional view of a device for measuring an angular movement at a gear rack.

### DETAILED DESCRIPTION

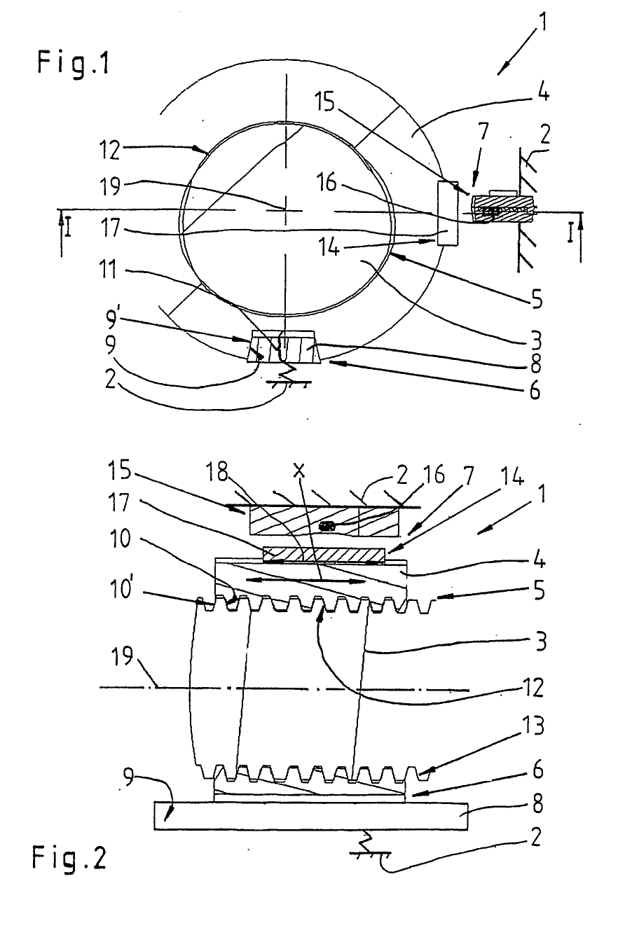

FIG. 1 is a schematic cross-sectional view of a device 1 for measuring an angular movement of a shaft 3 in a vehicle steering system.

Shaft 3 taking the form of a steering shaft is rotationally mounted in frame 2. The angular movement and the angular position of shaft 3 is to be absolutely determined by device 1. For this purpose, a detection device 7 is provided, which includes a transducer 14 that takes the form of a bar magnet and a sensor 15 that takes the form of a magnetoresistive sensor or sensor surface 16.

As FIG. 2 illustrates in a longitudinal cross-sectional view of device 1 for detecting an angular movement, taken along line I-I in FIG. 1, bar magnet 17 extends over an axial region 18 of an axially displaceable element 4 situated on shaft 3, and is affixed to this element 4.

Sensor 15 is positioned oppositely to bar magnet 17 at a short radial distance from it. Sensor 15 is fixed to frame 2. It may also be provided to mount the sensor on axially displaceable element 4 and to fix bar magnet 17 to the frame.

A geared connection 5 between shaft 3 and axially displaceable element 4, together with a longitudinal guide 6 mounted to frame 2 and positioned between it and axially displaceable element 4, cause axially displaceable element 4 to be axially displaced in arrow direction X illustrated in FIG. 2 when shaft 3 is rotated. In the exemplary embodiment illustrated, geared connection 5 takes the form of a thread or screw thread 12, e.g., a trapezoidal thread 13 having tip clearance. Cylindrical/sleeve-shaped, axially displaceable element 4 forms, together with trapezoidal thread 13 and shaft 3, a lead screw.

If bar magnet 17 moves with axially displaceable element 4 in response to rotation of shaft 3, magnetoresistive sensor 16 is magnetized or permeated by the field lines of bar magnet 17 and a signal, a planar Hall voltage or change in resistance, is generated in sensor 16. The signal may be evaluated by a control and/or regulating unit of the vehicle steering system and used for controlling a servomotor of the vehicle steering system. Axially displaceable element 4 may also be situated on a steering nut instead of on a steering shaft, the detection device then measuring the longitudinal movement of a gear rack.

In order for the device to have a high measurement accuracy while device 1 for measuring an angular movement requires as little space as possible, it may be necessary to have a backlash-free setting of longitudinal guide 6 and geared connection 5 between shaft 3 and axially displaceable element 4, the geared connection taking the form of a trapezoidal thread 13. For this purpose, a frame-side component 8 of longitudinal guide 6 is provided, which, in the exemplary embodiment illustrated, is prestressed or spring-loaded in the direction of longitudinal axis 19 of shaft 3 and axially displaceable element 4.

Frame-side component 8 of longitudinal guide 6 is brought into contact with axially displaceable element 4 at first oblique surfaces 9, 9′, which extend at an angle to each other and in the direction of longitudinal axis 19. In the exemplary embodiment illustrated, frame-side structural element 8 of longitudinal guide 6 has (first) oblique surfaces 9, and axially displaceable element 4 has (first) oblique surfaces 9′, as well. Oblique surfaces 9′ on axially displaceable element 4 take the form of trapezoidal surfaces approaching each other. Frame-side, spring-loaded structural element 8 of longitudinal guide 6 projects into consequently formed groove 11 in axially displaceable element 4, and its oblique surfaces 9 rest against oblique surfaces 9′ of groove 11 in a backlash-free manner.

Trapezoidal thread 13 provides second oblique surfaces 10, 10′ between axially displaceable element 4 and shaft 3, the second oblique surfaces having the same inclination directions with respect to each other as first oblique surfaces 9, 9′ of longitudinal guide 6. In addition, trapezoidal thread 13 has tip clearance, as does frame-side component 8 in groove 11, which means that frame-side, spring-loaded component 8 of longitudinal guide 6 causes all mentioned oblique surfaces 9, 9′, 10, 10′ to abut without backlash, and in this manner, device 1 is kept permanently backlash-free with a minimum of outlay.

The required space of device 1 is minimized, in that frame-side component 8 of longitudinal guide 6 is held flat and the main portion of its radial extension projects into groove 11 of axially displaceable element 4. Geared connection 5 may be a screw thread or a screw-like, sliding-block guide or a recirculating ball screw, etc.

In order to simplify the adjustment of detection device 7 and allow for installation tolerances of detection device 7, axial extension 18 of bar magnet 17 or transducer 14 should be selected to be greater than required by the structurally predetermined measuring range of the longitudinal movement of axially displaceable element 4.

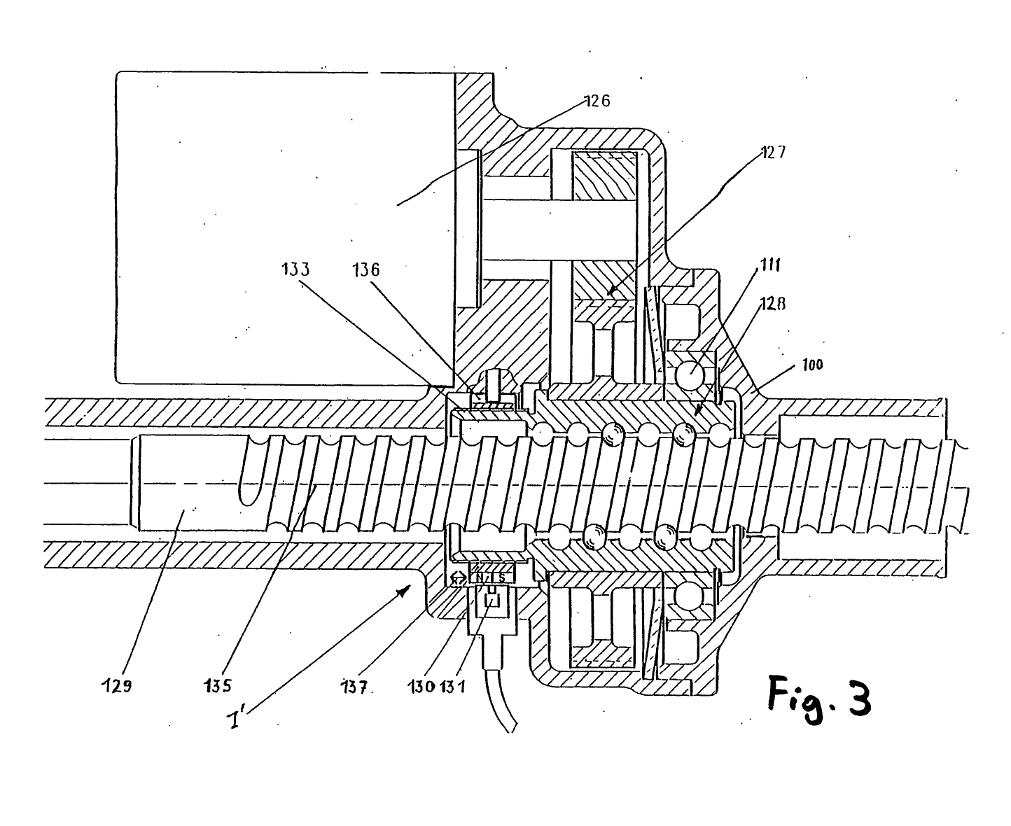

In FIG. 3, a measuring device 1′ is illustrated. The arrangement of the measuring device is illustrated on a gear rack 129 in a steer-by-wire system. This is provided with a ball-groove thread 135, which interacts with a steering nut 128. Steering nut 128 is supported in housing 100 by a bearing having a rolling element 111 and is driven by an electric motor 126 via a gear unit taking the form of a belt drive 127, which means that gear rack 129 or also pushrod may be deflected by a steering pinion, as assistance for manual deflection. To measure the steering movement, and consequently the steering angle as well, steering nut 128 is provided with a threaded part 133, on which a threaded nut 136 is positioned so as to be axially movable. Threaded part 133 and threaded nut 136 represent the rotationally mounted shaft and the axially displaceable element, which have oblique surfaces that are identically formed with respect to each other (see FIG. 2). Positioned on them are sensor components 130 and 131 for measuring axial movement 137 of threaded nut 136.

1-18. (canceled)

19. A device for measuring an angular movement in a vehicle steering system, comprising:
a shaft rotationally mounted in a frame;
a member positioned on the shaft, the member axially displaceable in a direction of the shaft and connected to the shaft by a geared connection that converts angular movement of the shaft into a longitudinal movement;
a longitudinal guide prestressed in a radial direction of the shaft, the member guided in an axial direction by the guide, a frame-side component of the guide resting against the member on first oblique surfaces that extend at an angle to each other and in the axial direction of the member, the member and the shaft meshing without backlash by second oblique surfaces of the geared connection, the first oblique surfaces between the frame-side component and the member and the second oblique surfaces of the geared connection having same inclination directions with respect to each other; and;
a detection device adapted to measure longitudinal movement of the member.

20. The device according to claim 19, wherein the member includes a nut, the shaft includes a threaded spindle and the frame-side component includes a thrust piece that radially presses the nut onto the threaded spindle.

21. The device according to claim 20, wherein the threaded spindle is arranged as a steering spindle.

22. The device according to claim 19, wherein the member includes a threaded nut and the shaft includes a threaded part arranged on a steering nut that drives a recirculating ball screw of a gear rack.

23. The device according to claim 19, wherein the frame-side component rests against the member at the first oblique surfaces.

24. The device according to claim 19, wherein the first oblique surfaces are arranged as part of a groove on the member and extends radially toward the shaft.

25. The device according to claim 19, wherein the first oblique surfaces and the second oblique surfaces include trapezoidal inclination directions.

26. The device according to claim 19, wherein the member is arranged around the shaft in the shape of one of (a) a ring, (b) a cylinder and (c) a polygon, the geared connection including a screw thread between the shaft and the member.

27. The device according to claim 26, wherein the screw thread is arranged as a trapezoidal thread having tip clearances.

28. The device according to claim 24, wherein a main portion of a radial extension of the frame-side component projects into the groove.

29. The device according to claim 19, wherein the frame-side component is prestressed in the radial direction toward the shaft to position the guide and the geared connection in a backlash-free manner.

30. The device according to claim 19, wherein the detection device includes a transducer positioned on the member and a sensor in communication with the transducer and arranged on one of (a) the frame and (b) the frame-side component.

31. The device according to claim 19, wherein the detection device includes a sensor arranged on the member and a transducer in communication with the sensor and arranged on one of (a) the frame and (b) the frame-side component.

32. The device according to claim 30, wherein the sensor includes a magnetoresistive sensor and the transducer includes one of (a) a bar magnet and (b) an annular magnet.

33. The device according to claim 31, wherein the sensor includes a magnetoresistive sensor and the transducer includes one of (a) a bar magnet and (b) an annular magnet.

34. The device according to claim 30, wherein the transducer has a greater axial extension than a structurally predetermined measuring range of the longitudinal movement of the member.

35. The device according to claim 31, wherein the transducer has a greater axial extension than a structurally predetermined measuring range of the longitudinal movement of the member.

36. The device according to claim 30, wherein one of (a) several sensors and (b) several transducers are positioned at least one of (a) over a circumference and (b) in the longitudinal direction of the member.

37. The device according to claim 31, wherein one of (a) several sensors and (b) several transducers are positioned at least one of (a) over a circumference and (b) in the longitudinal direction of the member.

38. The device according to claim 19, wherein the member is arranged on a steering shaft, the detection device adapted to measure rotation of a steering handle.

39. The device according to claim 19, wherein the member is arranged on a shaft arranged as a steering nut, the detection device adapted to measure a longitudinal movement of a gear rack.

40. A vehicle steering system, comprising:
a device adapted to measure an angular movement in the vehicle steering system, the device including:
a shaft rotationally mounted in a frame;
a member positioned on the shaft, the member axially displaceable in a direction of the shaft and connected to the shaft by a geared connection that converts angular movement of the shaft into a longitudinal movement;
a longitudinal guide prestressed in a radial direction of the shaft, the member guided in an axial direction by the guide, a frame-side component of the guide resting against the member on first oblique surfaces that extend at an angle to each other and in the axial direction of the member, the member and the shaft meshing without backlash by second oblique surfaces of the geared connection, the first oblique surfaces between the frame-side component and the member and the second oblique surfaces of the geared connection having same inclination directions with respect to each other; and;
a detection device adapted to measure longitudinal movement of the member.
